(19) United States
(12) Patent Application Publication
(10) Pub. No.: US 2018/0060861 A1
(43) Pub. Date: Mar. 1, 2018

(54) Payment Service Provider Agnostic Tokenization

(71) Applicant: Digital River, Inc., Minnetonka, MN (US)

(72) Inventor: Rickard Bo Schoultz, Stockholm (SE)

(21) Appl. No.: 15/683,831

(22) Filed: Aug. 23, 2017

Related U.S. Application Data
(60) Provisional application No. 62/378,493, filed on Aug. 23, 2016.

(51) Int. Cl. G06Q 20/38

(52) U.S. Cl. CPC G06Q 20/38215; G06Q 20/3829

(57) ABSTRACT

A system and method allows a merchant to transact credit card payments with any payment service provider that supports client-side encryption with neither merchant nor payment service provider storing personal card holder data. Payment service providers register encryption keys with the tokenization service provider and receive an identifier that is stored by the merchant. Customers provide payment details on the merchant website, which are sent to the tokenization service provider which stores card holder data and returns a token to be stored by the merchant. When a payment transaction is initiated, the merchant retrieves encrypted card holder data from the tokenization service provider and sends it to the selected payment service provider along with other transaction details. Merchants may reuse tokens with any payment service provider without having to transfer personal card information.

### RELATED APPLICATIONS

This application claims the benefit of U.S. Provisional Application No. 62/378,493 filed 23 Aug. 2016, entitled “Payment Service Provider Agnostic Tokenization,” which is incorporated herein by reference.

### BACKGROUND

Aspects of the present disclosure relate to performing payment transactions using payment service provider agnostic tokens provided by a tokenization service provider storing credit and debit card details in a PCI DSS compliant system.

Payment Service Providers process card payments with card holder information on behalf of a merchant using a connection to an acquiring bank or with direct connection to a network like VISA or Mastercard. A merchant must be certified with the Payment Card Industry Data Security Standards (PCI DSS) in order to process payments and store or pass a card number to a Payment Service Provider. As a PCI DSS audit and certification usually is a large and expensive undertaking, Payment Service Providers have invented various ways of protecting merchants from exposure to card numbers and other card holder data. Prior work in this space includes Payment Pages and Client-side Encryption (CSE). Payment pages are hosted by Payment Service Providers. Merchants can redirect clients to payment pages for the purpose of card number entry. Client-side encryption is a method for capturing card holder data on the user device but encrypting it before passing on the payment form to the merchant for further processing with a Payment Service Provider. In both cases, the merchant still has to go through the PCI Council's Self-Assessment, though they are not subject to the full PCI audit.

Payment Service Providers typically also provide some form of Tokenization, a process by which the merchant can have card holder data tokenized for further processing in subsequent requests. The merchant either sends the card holder data from the merchant system or utilizes some other method like the payment page or CSE. The card number, expiration date, and optionally more parameters, are stored on the Payment Service Provider's Tokenization Service (also known as Vault), and can be referenced by the token in subsequent transactions like recurring billing or for use of stored payment methods. The problem with this method is that the tokenized card holder data is locked to the Payment Service Provider, and there is no way for the merchant to process a transaction using that token with another Payment Service Provider unless the card holder data is exported from the first PSP and imported to the other. This is a common method for moving card holder data when a merchant switches PSPs.

Given the foregoing, there is a need in the art of payment tokenization for supporting merchants with an improved method for simplifying reuse of tokens across Payment Service Providers without requiring a migration of the card holder data or that would require the merchant to store the card holder data and therefore be subject to the PCI DSS. The system and method disclosed herein fulfill that need and offer other advantages over the prior art.

### SUMMARY

A system and method for performing a payment service provider agnostic payment transaction is disclosed that allows a web merchant and payment service provider to perform payment transactions with neither storing card holder private data. Further, merchants are not locked into using a particular payment service provider.

In one embodiment, a system for performing a payment service provider agnostic payment transaction with personal card holder data stored only on a tokenization service provider PCI-compliant database is described. The system comprises a first server associated with a merchant's webpage and webstore for purchasing goods or services, communicatively coupled with an end user computing device. In providing a webstore for the sale of goods and services, the first server receives payment details from the end user associated with an online purchase, including payment method detail. The merchant transmits the card data details to a second server, a tokenization service provider (TSP), for tokenization and storage. The TSP transmits the token ID to the merchant. When a transaction is about to be processed, the merchant selects a PSP (third server) using a number of criteria, as described herein, the PSPs having registered an encryption key with a tokenization service provider (TSP) and been assigned an identifier, which has been provided to the merchant. The first server transmits a request to resolve the token and PSPID to the second server (TSP). The TSP retrieves the card holder data from the database, generates a transport encryption key, encrypts the card holder data with the transport encryption key, and uses the PSP's public key to encrypt the transport encryption key, creating an encrypted payload (encPayload). The merchant then calls the third server, the PSP API, to process a card transaction using the encPayload and other transaction details (e.g. transaction amount). The payload is decrypted, the payment processed, and confirmation details returned to the first server.

### BRIEF DESCRIPTION OF THE DRAWINGS

FIG. 1 provides an overview of one embodiment of the disclosed system.

FIG. 2 is a flow chart describing a method for registering a payment service provider with a tokenization service provider and merchant, consistent with the disclosed embodiments.

FIG. 3 is a flow diagram illustrating the method consistent with the disclosed embodiments.

FIG. 4 illustrates the subsystems involved in a system for payment service provider agnostic payment processing

### DETAILED DESCRIPTION

Embodiments of the present invention may be described more fully hereinafter with reference to the accompanying drawings, in which some, but not all, embodiments of the invention are shown. The invention may be embodied in many different forms and should not be construed as limited to the embodiments set forth herein; rather, these embodiments are provided so that the disclosure may enable one of ordinary skill in the art to make and use the invention Like numbers refer to like components or elements throughout the specification and drawings.

A Payment Service Provider Agnostic Tokenization system and method allows a merchant to transact credit card payments with any PSP that supports client-side encryption (CSE) with neither merchant nor PSP storing personal card holder data. A TSP stores card holder data and provides the merchant with a token, which is stored by the merchant. When a payment transaction is initiated, the merchant retrieves encrypted card holder data from the TSP and sends it to the selected PSP, identified by a PSPID (PSP identifier code).

Client-Side Encryption (CSE) is a method of encrypting sensitive data such as a card number before it is transmitted to a server such as a commerce engine hosted by a merchant. CSE features an asymmetric encryption key that renders the sensitive data unavailable to anyone but the PSP. As an example of a CSE method, the sender generates an ephemeral transport encryption key (TEK), encrypts the card holder data with the TEK, looks up the PSP public key and uses that as a key encryption key to encrypt the TEK.

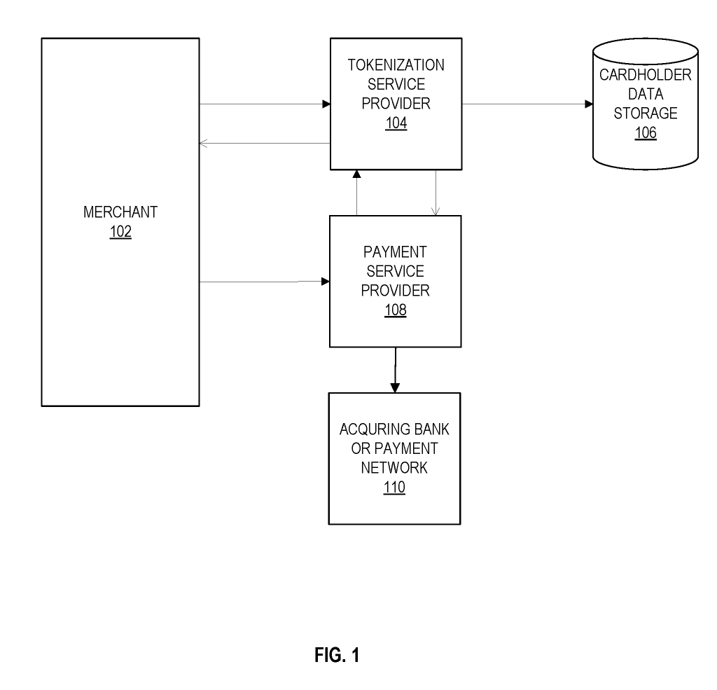

FIG. 1 illustrates one embodiment of a system for allowing payment service provider agnostic transactions. A merchant 102 may host an ecommerce web site, offering goods or services. The merchant may deal with multiple payment service providers (PSP) 108. The choice of PSP for any particular transaction may be made based on several factors, including location (region and accepted currencies), payment methods offered/accepted, processing rates, customer choice, flexibility and others. In this and other embodiments, a tokenization service provider (TSP) 104 may store the merchant customer credit card data 106. Upon receiving a credit card transaction, the merchant 102 may forward the data to the TSP, who writes the data to storage, generates a token, and returns the token to the merchant. The merchant 102 stores the token rather than the credit card data. Alternatively, the merchant 102 is delegating the task of capturing the card number from the card holder to a third-party payment page that acts on behalf of a merchant. The payment page sends the data to the TSP, who writes the data to storage, generates a token and returns the token to the merchant.

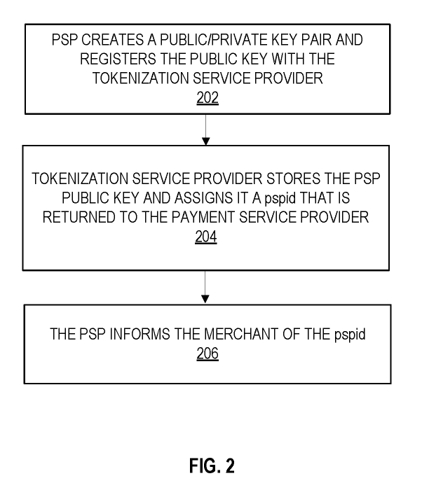

FIG. 2 illustrates the registration of a PSP 108 with the TSP 104. The PSP 108 may create a public/private key pair and register the public key with the TSP 104, 202. The TSP 104 assigns a PSPID to each PSP 108, 204. The PSP 108 informs the merchant 102, 206 of the PSPID.

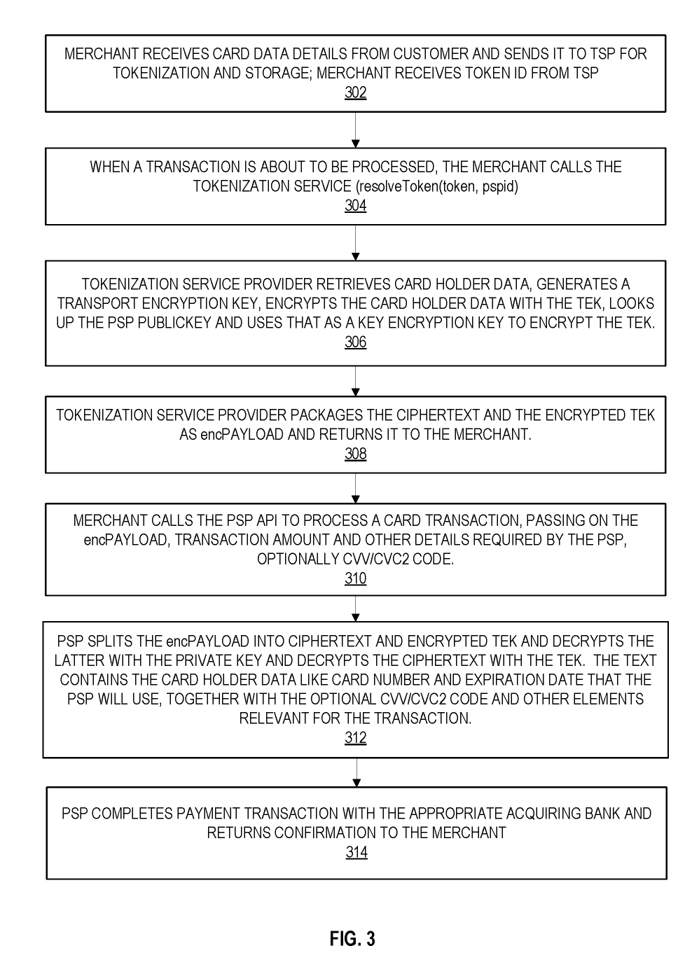

FIG. 3 is a flow chart of an exemplary method for providing Payment Service Provider Agnostic Tokenization. When a merchant or payment page service receives payment details from a shopper, the merchant or payment page service prepares to make the customer payment transaction by associating the customer with a stored token representing the card holder data 302. If the payment is being made by a first-time customer, or a current customer with new payment details, the merchant or payment page service will first send a request for tokenization to the TSP, where the data is stored and tokenized. The token is returned to the merchant. The merchant contacts the TSP 304 with the token and the PSPID of the selected PSP, (resolveToken(token, PSPID). The TSP 104 retrieves the card holder data 306 from the PCI compliant database 106, looks up the CSE encryption method for the PSP 108 and the public key of the merchant to be used with the PSP, encrypts the card holder data using the CSE method and returns the resulting encrypted payload to the merchant 102, 308. The merchant calls the PSP API 310 to process a card transaction 208, passing the encPayload, transaction amount, and other details required by the PSP, optionally including the CVV/CVC2 code and other data required for the transaction. The PSP receives the encPayload, splits the encPayload into ciphertext and encrypted TEK, and decrypts the latter with the private key, and decrypts the ciphertext with the TEK 312. The text contains the cardholder data like card number and expiration date that the PSP will use, together with the optional CVV/CVC2 code and other elements relevant for the transaction. The PSP processes the transaction with the acquiring bank or payment network 110, 314 which receives the full credit card number for a transaction, but may not store the data. Confirmation details, with no personal card holder data, is returned to the merchant 102 and the merchant notifies the customer that the order is complete.

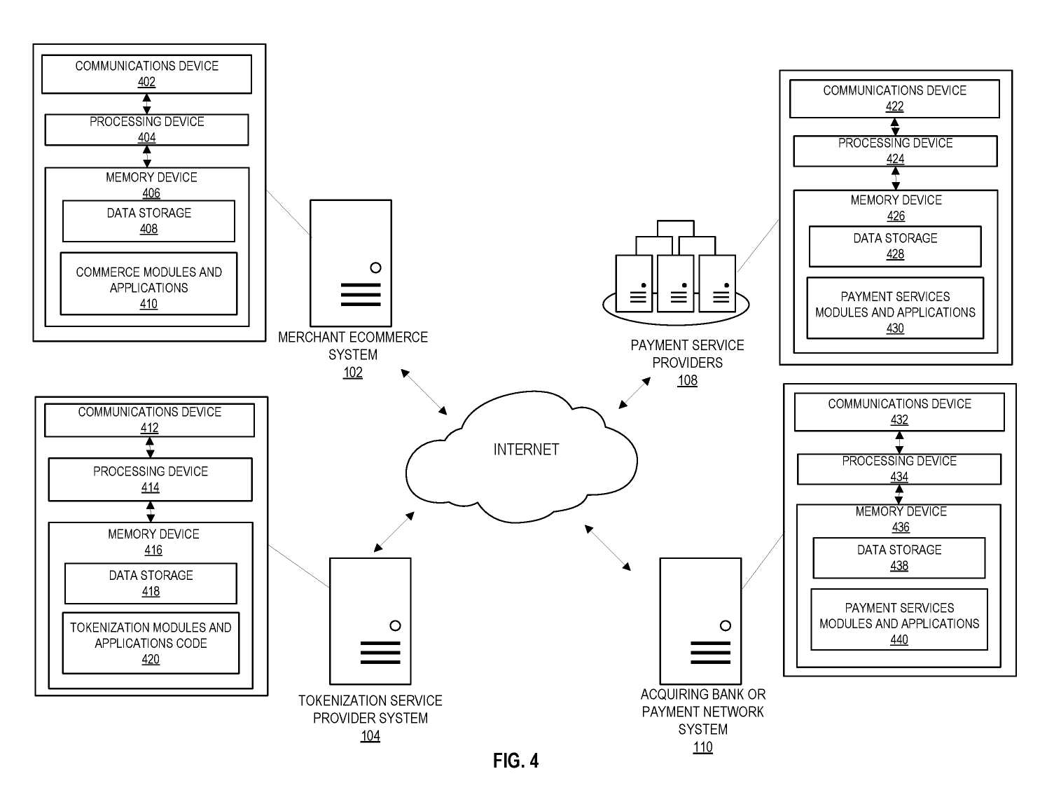

FIG. 4 illustrates a system consistent with embodiments of this disclosure. As is illustrated in FIG. 1, a merchant ecommerce system 102 hosts catalog and shopping cart that may receive orders for goods/services from customers. The merchant ecommerce system includes a computing device with communications 402, processor 404 and memory 406 components. The memory device further contains data storage 408 and commerce modules and applications 410 containing program code, which when executed by the processing device (computer processor) 404 perform the functions required of the ecommerce system. The merchant ecommerce system 102 may be connected to the Internet, to a number of payment service providers 108 and to a tokenization provider system 104. Communications between these special purpose systems are generally synchronous and in real time, especially when triggered by customer interaction, for example.

A tokenization provider system 104 provides services to a merchant ecommerce system 102 and payment service provider 108. The tokenization provider system provides reusable credit card data tokens that may be used with any chosen payment service provider. The tokenization system resides on a computing device in non-transient memory with communications 412, processor 414, and memory 416 components. The memory component further contains data storage 418 and modules and applications 420 containing program code, which when executed by the processing device (computer processor) 414 perform the tokenization and encryption functions required of the tokenization system. The tokenization system also includes (FIG. 1, 106) additional secure, PCI DSS compliant data storage for card holder data and for payment service provider records 104.

A merchant ecommerce system 102 may be connected to many payment service providers 108.

As was discussed above, the merchant 102 may select a payment service provider 108 based on several factors. Using a payment service provider agnostic method, the merchant reuses card holder data tokens by substituting the payment service provider's PSPID in the (resolveToken(token, PSPID) call to the TSP 104. The TSP 104 retrieves the card holder data from secure storage 106, generates a transport encryption key (TEK), encrypts the card holder data with the TEK, looks up the PSP public key for the PSPID and uses that as a key encryption key to encrypt the TEK. The TSP 104 packages the ciphertext and the encrypted TEK as encPayload and returns that to the merchant, who calls the PSP 108 with encPayload to perform the transaction. The payment service provider system resides in non-transient memory on a computing device with communications 422, processor 424, and memory 426 components. The memory component further contains data storage 428 and modules and applications 430 containing program code, which when executed by the processing device (computer processor) 424 perform the communications, decryption and transaction processing functions required of the payment service provider 108 system. A payment service provider 108 supports receiving encrypted payloads of card holder data. In some embodiments, a tokenization service provider 104 may provide the encrypted payload with PSP specific named fields,

In some embodiments, a tokenization service provider 104 may provide the encrypted payload with PSP specific named fields similar to their implementation of client-side encryption. A PSP that provides the merchant with the option to utilize CSE provides instructions to the merchant about the naming of the fields that are subject to encryption, so that the PSP can interpret the fields correctly upon receiving a request with fields encrypted with CSE. In order to meet the requirements of each PSP, the TSP may need to name the fields different depending on what PSP the merchant intends to send the encrypted data to.

In some embodiments, a tokenization service provider may provide the encrypted payload with PSP specific encryption libraries according to their requirements for client-side encryption. A PSP that provides CSE functionality for merchants and provides a library to be distributed by the merchant for use in the encryption and packaging of the card holder data by the clients of the merchant. In order to successfully encrypt and package the card holder data, the merchant may have to distribute the library to the TSP so that the TSP can encrypt the card holder data in a manner that can be used by the PSP.

Each payment service provider 108 is connected to an acquiring bank or payment network system 110 that handles credit and debit card, or other payment type, processing. The bank or payment system resides in non-transient memory on a computing device with communications 432, processing 434, and memory 436 components. The memory component further contains data storage 438 and modules and applications 440 containing program code, which when executed by the processing device (computer processor) 414 perform the card processing functions required of the bank. Communications between these special purpose systems may be synchronous and in real time, especially when triggered by customer interaction, for example.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Non-transitory computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Computer program code for carrying out operations of embodiments of the present invention may be written in an object oriented, scripted or unscripted programming language such as Java, Scala, Perl, Smalltalk, C++, or the like. However, the computer program code for carrying out operations of embodiments of the present invention may also be written in conventional procedural programming languages, such as the “C” programming language or similar programming languages.

These computer program instructions may be stored in a non-transitory computer-readable memory that can direct a computer or other programmable data processing apparatus to function in a particular manner, such that the instructions stored in the computer readable memory implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

It will be understood that by having a single subsystem in the payment system store credit card holder data, that only that system needs PCI DSS full certification. Merchants may store a token and an identifier for a PSP and call a selected PSP API without having to move customer payment information from one PSP to another.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for performing a payment service provider agnostic payment transaction by a first server, the first server associated with a webpage and webstore communicatively coupled to a second server associated with a tokenization service provider, the first and second servers both communicatively coupled to a third server associated with a payment service provider registered with the tokenization service provider, the method comprising:
receiving, at the first server, payment details for the payment transaction associated with an online purchase;
transmitting the payment details and an identifier for a select payment service provider to the second server, the second server storing the payment details in a secure PCI compliant database and encrypting the payment details;
receiving, at the first server, an encrypted payload comprised of the encrypted payment details, the payload further encrypted using a registered public key of the selected payment service provider;
transmitting the encrypted payload, and other transaction details to the selected third server payment service provider for decryption and payment processing.

2. The method of claim 1, wherein the registration of a payment service provider with the tokenization service provider includes registration of a public key for generating a transport encryption key.

3. The method of claim 1, wherein decryption of the encrypted payload at the payment service provider includes splitting the payload into ciphertext and transport encryption key, the transaction encryption key decrypted with the private key registered with the tokenization service provider.

4. The method of claim 1 wherein the card holder data is stored only in the tokenization service provider secure, PCI compliant database.

5. A system for performing a payment service provider agnostic payment transaction with personal card holder data stored only on a tokenization service provider PCI-compliant database, comprising:
a first server associated with a webpage and webstore communicatively coupled with an end user computing device for purchasing goods or services, the server further comprising memory and a processor, with executable instructions stored in memory which when executed by the processor receive payment details from an end user for a payment transaction associated with an online purchase, transmit the payment details and an identifier for a select payment service provider to a second server, receive an encrypted payload and transmit the payment transaction details to a third server for decryption and payment processing;
a second server associated with a tokenization service provider, the tokenization service provider comprising a PCI compliant database for storing payment card holder data and registration details for the first server and plurality of payment service providers, further comprising processor, memory and executable instructions stored in memory, which when executed by the processor perform the steps of writing the card holder data to the secure PCI compliant database, creating an encrypted payload of the card holder data specific to the selected payment service provider and transmitting the encrypted payload to the first server; and
a third server associated with a payment service provider, comprising processor, memory and executable instructions stored in memory, which when executed by the processor perform the steps of receiving the encrypted payload and processing the payment transaction.
